(19) United States
(12) Patent Application Publication
(10) Pub. No.: US 2026/0014044 A1
(43) Pub. Date: Jan. 15, 2026

(54) BALANCE-ASSISTIVE DEVICE AND SYSTEM

(71) Applicants: Nanyang Technological University, Singapore (SG); Tan Tock Seng Hospital Pte Ltd, Singapore (SG)

(72) Inventors: Wei Tech ANG, Singapore (SG); Lei LI, Singapore (SG); Shi Wei WU, Singapore (SG); Youlong WANG, Singapore (SG); Jiaying CAI, Singapore (SG); Jiaye CHEN, Singapore (SG); Ming Jeat FOO, Singapore (SG); Kuan Yuee TAN, Singapore (SG); Sui Geok Karen CHUA, Singapore (SG); Seng Kwee WEE, Singapore (SG); Wee Keong Christopher KUAH, Singapore (SG); Huiting ZHUO

(21) Appl. No.: 18/875,577

(22) PCT Filed: Jun. 22, 2023
(86) PCT No.: PCT/SG2023/050442

§ 371 Date: Dec. 16, 2024

(30) Foreign Application Priority Data
Jun. 23, 2022 (SG) 10202250267X

(51) Int. Cl. A61H 3/00

(52) U.S. Cl. CPC A61H 3/008; A61H 2003/007; A61H 2201/163; A61H 2201/1652; A61H 2201/5061

(57) ABSTRACT

A device having a support interface and one or more sensors disposed to sense forces exerted on the support interface. The device includes a linkage structure having a plurality of lower-pair joints and a plurality of linkages. The support interface is coupled to one of the plurality of linkages. Each of the plurality of lower-pair joints couples two of the plurality of linkages such that the linkage structure defines a closed kinematic chain. A selected plurality of the lower-pair joints is a plurality of lockable lower-pair joints. Each of the plurality of lockable lower-pair joints has a locally actuatable braking mechanism that is actuatable independently of any other of the plurality of lower-pair joints.

### CROSS-REFERENCE TO RELATED APPLICATION

The present application is the national stage filing of International Application PCT/SG2023/050442, filed Jun. 22, 2023, which claims the benefit of priority to the Singapore Application No. 10202250267X filed Jun. 23, 2022, the contents of which are hereby incorporated by reference in their entirety for all purposes.

### TECHNICAL FIELD

This application relates to assistive apparatus suitable for use in daily living assistance and rehabilitation therapy.

### BACKGROUND

The degeneration of the human balance control system happens in the natural ageing process and in many pathologies such as neurological insults, musculoskeletal problems, and vestibular deficits. The degenerated balance control system also heightens the risk of falls. More than one out of four older people fall each year. Meanwhile, falls have been documented to be the single most important factor in patient injuries during the period of undergoing rehabilitation therapy in both inpatient and outpatient cases.

### SUMMARY

In one aspect, the present application discloses a device, the device including a support interface: one or more sensors disposed to sense forces exerted on the support interface; and a linkage structure having a plurality of lower-pair joints and a plurality of linkages, the support interface being coupled to one of the plurality of linkages, each of the plurality of lower-pair joints coupling two of the plurality of linkages such that the linkage structure defines a closed kinematic chain, wherein a selected plurality of the lower-pair joints is a plurality of lockable lower-pair joints, each of the plurality of lockable lower-pair joints having a locally actuatable braking mechanism that is actuatable independently of any other of the plurality of lower-pair joints.

In another aspect, the present application discloses a balance-assistive system for use with a user. The balance-assistive system includes: a support interface having a harness, the harness being wearable by the user: one or more sensors disposed to sense forces exerted on the support interface by the user: a linkage structure having a plurality of lower-pair joints and a plurality of linkages, the support interface being coupled to one of the plurality of linkages, each of the plurality of lower-pair joints coupling two of the plurality of linkages such that the linkage structure defines a closed kinematic chain, wherein a selected plurality of the lower-pair joints is a plurality of lockable lower-pair joints, each of the plurality of lockable lower-pair joints having a locally actuatable braking mechanism that is actuatable independently of any other of the plurality of lower-pair joints: a base, the linkage structure being coupled to the base; and a controller, the controller being configured to lock the selected plurality of the lower-pair joints in response to determining an abnormality in the forces sensed, such that respective pairs of the plurality of linkages are locked relative to one another.

### BRIEF DESCRIPTION OF THE DRAWINGS

Various embodiments of the present disclosure are described below with reference to the following drawings:

FIG. 1 is a schematic diagram illustrating a system according to embodiments of the present disclosure:

FIG. 2A is a perspective view of one embodiment of the system of FIG. 1 in an elevated state:

FIG. 2B is a perspective view of the system of FIG. 2A in a compact state:

FIG. 3A is a perspective view of one embodiment of a device in an extended state:

FIG. 3B is a perspective view of the device of FIG. 3A in a retracted state:

FIG. 4A is a schematic top view of the device of FIG. 3A in the extended state:

FIG. 4B is a schematic top view of the device of FIG. 3B in the retracted state:

FIG. 5A is a perspective view of the device of FIG. 3A:

FIG. 5B is a partial side view of FIG. 5A:

FIG. 6 is a schematic top view of a device according to another embodiment:

FIG. 7 is a schematic top view of a device according to yet another embodiment:

FIG. 8A is a perspective view of a lockable joint according to an embodiment of the present disclosure:

FIG. 8B is an exploded view of the lockable joint of FIG. 8A:

FIG. 9A is a perspective view of the lockable joint according to another embodiment of the present disclosure:

FIG. 9B is an exploded view of the lockable joint of FIG. 9A:

FIG. 10A is a perspective view of another embodiment of the system of FIG. 1 in an elevated state:

FIG. 10B is a perspective view of the system of FIG. 10A in a compact state;

FIG. 11 is a perspective view of another embodiment of the device of FIG. 10A in an extended state:

FIG. 12 is a schematic top view of the device of FIG. 11 in the extended state:

FIG. 13 is a perspective view of the device of FIG. 11 with a detailed side view of a sensor;

FIG. 14 is a schematic diagram of a method implementable with the device of FIG. 1:

FIG. 15A is a perspective view of another embodiment of the system in an elevated state:

FIG. 15B is a perspective view of the system of FIG. 15A in a compact state:

FIG. 16A is a perspective view of another embodiment of the device in an extended state;

FIG. 16B is a perspective view of the device of FIG. 16A in a retracted state:

FIG. 17A is a perspective view of the device of FIG. 16A; and

FIG. 17B is a partial side view of FIG. 17A.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

To aid understanding and not to be limiting, a detailed description of various embodiments of a device 200 and a system 900 will be described below with reference to the appended figures. The device 200 may also be described as a balance assistive mechanism as it is useful for assisting a user to regain/achieve balance so as not to fall completely down to the ground.

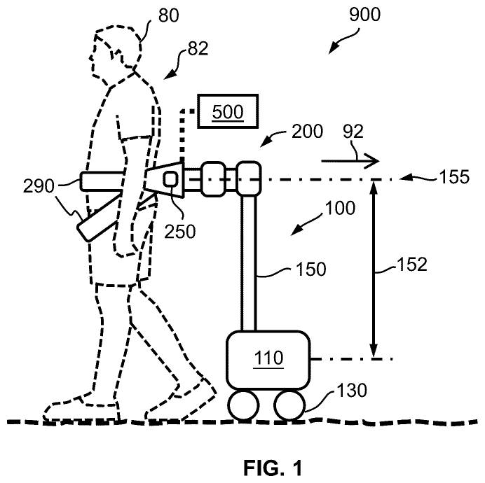

FIG. 1 is a schematic diagram of the system 900 for use by a user 80 or patient according to an embodiment. As non-limiting examples, the user 80 may be a wheelchair user, elderly person with walking disability, stroke patients, person with risk of falling, etc. The system 900 may be employed to render assistance or support to the user 80 during activities, such as during daily tasks, walking, postural balance training, gait rehabilitation, physical sports activities, etc. The system 900 is able to provide support to the user in a variety of situations. For example, the system 900 may be used to provide support to the user when the user does not fall. For example, the user may use the system 900 as a general support when carrying out daily tasks with a greater peace of mind, knowing that at a time/instant of a fall (or upon prediction/detection of a potential fall), the system 900 will help to prevent an injurious fall. The system 900 may be a mobile or portable system such that the system 900 may be employed in a home or community setting. The system 900 is not limited to use in a hospital or institutional setting. Advantageously, the device 200 may be provided as a modular unit for interchangeable installation on different articles or rehabilitative equipment.

In some embodiments, the system 900 may include a mobile unit 100 having a base 110 and wheels 130. A device 200 according to any one of the embodiments disclosed herein may be coupled to the base 110 of a stationary unit or a mobile unit 100. In use, the device 200 is preferably positioned at the back 82 of the user 80, and the device 200 is configured to provide a generally backward and/or upward force 92 to support the user 80. The terms “backward” and “upward” are loosely used herein with reference to the user and/or the ground. As used herein, the terms/phrases “support”, “providing a support”, “supporting”, and the like, may be generally understood as providing a point/surface of support to the user either directly by means of a direct contact with the user or indirectly. A supporting force or a force in a supporting direction refers generally to a force or a direction that supports the user against a fall or a potential fall. Since the manner in which a user may fall varies from case to case, as used herein, the terms “supporting force” and/or “supporting direction” are not limited to one absolute value but should be understood functionally in context.

In some embodiments, the device 200 includes a controller 500 in signal communication with one or more sensors 250 that are coupled to the device 200. Examples of the sensors 250 may include force sensors, pressure sensors, distance/range sensors, strain gauges, multiple-axis force sensors, etc. The controller 500 may be in signal communication with the sensors 250 to receive respective sensor signals. Further, the controller 500 may also control the device 200 to actuate and provide a support to the user 80.

In some embodiments, the mobile unit 100 is configured as an autonomous vehicle. The mobile unit 100 may be configured to actively drive itself in following the user/patient instead of being passively pulled along by the patient or pushed by a care giver. The controller 500 may be part of the mobile unit 100 and configured to receive sensor signals from the one or more sensors 250 directly or indirectly. Alternatively, the controller 500 may be part of the device 200 and configured to be in signal communication with the mobile unit 100 such that the controller 500 may cause the mobile unit 100 to stop moving forward in response to a predicted fall or a start of a fall. A wired or wireless signal communication may be provided between the controller 500 and the mobile unit 100. In some embodiments, the controller 500 may be integrated with the mobile unit 100. In other embodiments, the controller 500 may be disposed remote from the system 900. In other embodiments, the controller 500 may be in wireless signal communication with a local or a remote monitoring device, e.g., such that a medical professional may be updated in a timely manner with a status of the user 80.

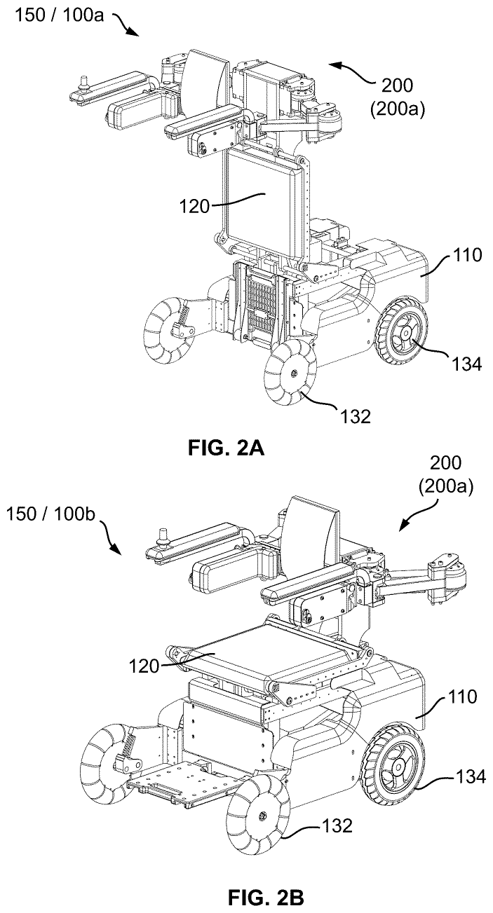

FIGS. 2A and 2B illustrate a system 900 according to an embodiment showing the mobile unit 100 with the device 200 in assembly therewith. As illustrated in FIGS. 2A and 2B, the mobile unit 100 may be convertible between an elevated state 100a (FIG. 2A) and a compact state 100b (FIG. 2B).

When the mobile unit is in the elevated state 100a, the device 200 is elevated relative to the base 110, with the base 110 remaining near the ground. In the compact state 100b, the device 200 may be tucked unobtrusively closer to the base 110. In this example, the device 200 may form part of the handles for use in pushing the system 900 like a wheelchair.

A seat 120 is optionally provided and may be coupled to the base 110. In some embodiments, the seat 120 is pivotably or hingedly coupled on opposing sides/edges to the device 200 and the base 110 respectively. With a rotation or pivot of the seat 120, the mobile unit 100 may be converted from the elevated state 100a to the compact state 100b, and vice versa. The seat 120 may be part of a structural support for the device 200 when the latter is elevated, i.e., when the mobile unit 100 is in the elevated state 100a. The seat 120 may serve to support a seated user when the mobile unit 100 is in the compact state 100b. It may be appreciated that the mobile unit 100 may assume other configurations and need not be in a wheelchair form in any of the elevated state 100a and the compact state 100b.

In some embodiments, the mobile unit 100 is non-convertible and essentially permanently in a state corresponding to the elevated state 100a. This enables the base 110 to have a shorter depth (e.g., a shorter distance between the front wheels 132 and the back wheels 134) and have a smaller footprint since a minimum depth would not be required to accommodate a seated user. Using FIG. 1 and FIG. 2A for convenient reference, in embodiments where the mobile unit 100 is non-convertible, the device 200 is supported at an elevation or a device height 152 relative to the base 110 or relative to the center of gravity of the base 110. The support 150 for the device 200 may be adjustable so that the device height 152 puts the harness 290 at the hips, the waist, the chest, the shoulders, and/or in a region in the upper body of the user (for the sake of brevity, as used herein, the term “torso” will refer generally to a part or to all of the user's body from the shoulders to the hips/thighs where a harness or a safety belt may contact/engage the user 80). Preferably, in some embodiments, the harness 290 is secured comfortably about the torso so that the harness 290 can provide support to the user 80 while leaving the arms and legs of the user 80 free to perform the desired activities. Preferably, in other embodiments, the harness 290 includes a belt that can go around the thigh or crotch to provide support for the user's body weight. Preferably, in some embodiments, the harness 290 incudes a belt that can go around each thigh near the crotch and a belt that can go around the waist/hips.

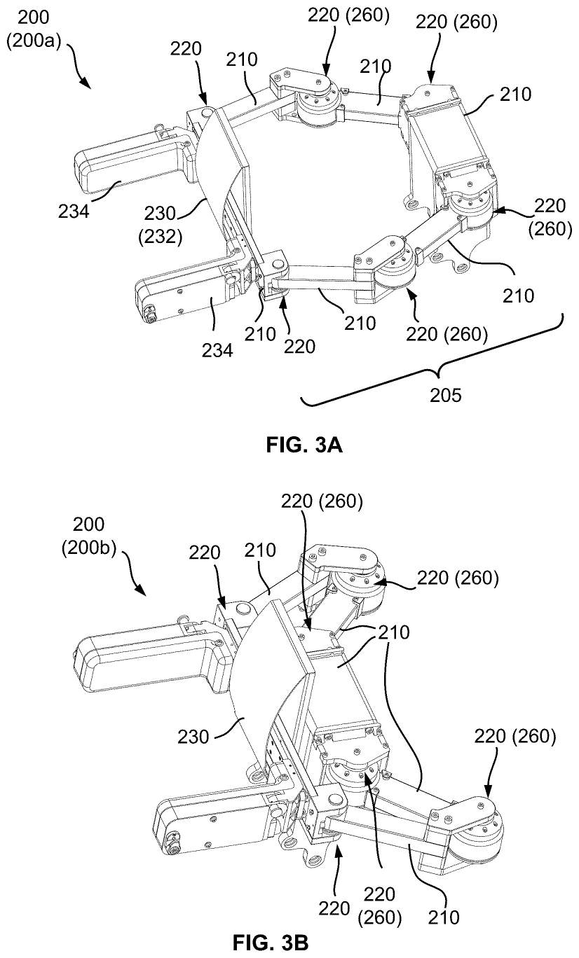

FIGS. 3A and 3B are perspective views illustrating one embodiment of the device 200 in greater detail. The device 200 may include a linkage structure 205 having a plurality of linkages 210 and a plurality of lower-pair joints 220, and a support interface 230 coupled to the linkage structure 205 or the linkages 210 for providing support to the user 80. The term “lower-pair joint” as used herein is to be understood to be a joint that constrains contact between a surface in a first body to a corresponding surface in a second body, and may include but not be limited to a revolute joint, a prismatic joint, a screw joint, a cylindrical joint, a universal joint, a spherical joint, a planar joint, a parallelogram joint, etc. Each of the lower-pair joints 220 may be coupled between a respective pair of linkages 210. Therefore, the plurality of linkages 210 and the plurality of lower-pair joints 220 operably coupled to collectively form the linkage structure 205, thereby enabling a relative movement of the support interface 230 relative to the base 110.

One or more of the lower-pair joints 220 is an independently lockable joint 260, i.e., a lockable joint that is also an independent joint. The lockable joint 260 is a free-joint when not actuated, and is lockable upon actuation. When a selected lockable joint 260 is actuated, the respective linkages 210 connected to the selected lockable joint 260 are locked in position and/or orientation relative to one other. As used herein, an independently lockable joint refers to a joint which is lockable (i.e., actuatable from an unlocked state to a locked state) and releasable (from a locked state to an unlocked state) in response to a signal from the controller and/or the sensor, independently of the locked/unlocked state of any other joint in the device, and regardless of the relative position/orientation of the linkages at the time instant of locking or unlocking.

For example, the independently lockable joint 260 of the present device 200 is operably coupled to respective ends of two linkages 210. Each linkage 210 has a respective range of motion. The independently lockable joint 260 may change from the unlocked state to locked state with each of the linkages 210 in any position in the respective range of motion. That is, the independently lockable joint 260 is lockable at any time, regardless of the absolute or the relative position/orientation of any of the linkages 210 at the time, and regardless of the state of any other joint in the device 200. This enables the device 200 to rapidly change from a lower-inertia compliant state to a rigid body upon locking. The lockable joints in the present device 200 are configured to be independently and directly operable without a need for a delayed response from a cascading actuation. This is in contrast to a cascading configuration in which one central locking mechanism triggers an initial lock in a cascade, which in turn triggers a next lock in the cascade.

In some embodiments, all of the lower-pair joints 220 are lockable lower-pair joints 260 to provide redundancy. In such cases, the linkage structure 205 may be locked in position as long as a minimum number of lockable joints 260 (also referred to as selected lockable lower-pair joints) are actuated. For each of various embodiments of the device 200, the minimum number of lockable joints 260 and the number of Degrees-of-Freedom (DOF) of the linkage structure 205 may be pre-determined and the controller 500 may be configured accordingly to actuate at least the minimum number required of lockable joints 260, or to select the lockable joints 260 such that the device 200 as a whole can be in one of two states: a compliant state and a rigid state, with a relatively rapid response in changing from the compliant state to the rigid state.

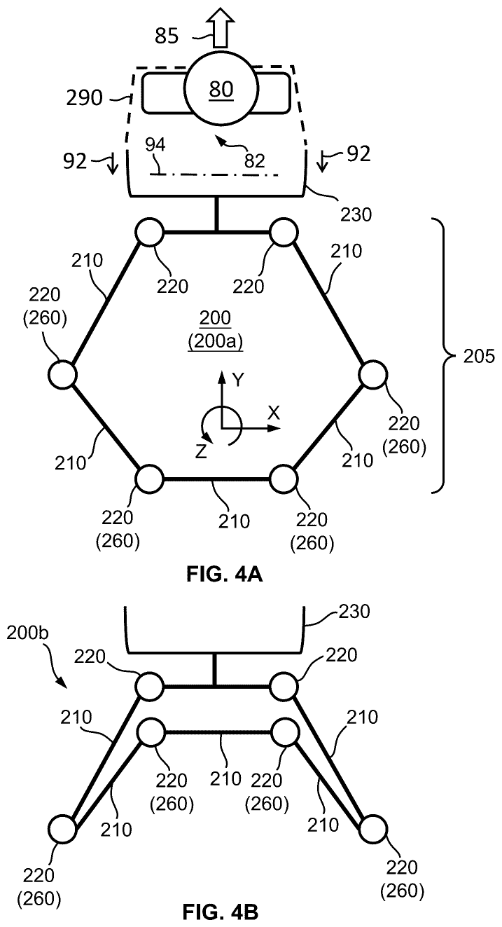

In the example as shown in FIGS. 3A to 4B, one embodiment of the linkage structure 205 may be represented as a closed kinematic chain with six interconnected linkages 210 and six lower-pair joints 220 or revolute joints 220 at respective interconnections. In this configuration, the linkage structure 205 provides a 3-DOF movement of the support interface 230 relative to the base 110, i.e., translation along an X-axis, translation along a Y-axis (generally, the “forward” direction in FIG. 4A) and a rotation about a Z-axis. In addition, the hexagonal structure allows the linkage structure 205 to be foldable between the extended state 200a (FIG. 3A) and the retracted state 200b (FIG. 3B). In this example, four of the six lower-pair joints 220 are lockable joints 260 and each of the four lockable joints is actuatable independently of any of the other joints. Upon actuating all of the four lockable joints, the linkage structure 205 is restricted and prevented from movement in all of the 3-DOF directions. The result is that the entire linkage structure 205 instantaneously changes from a compliant body into a rigid body, locking the support interface 230 in position relative to the base 110.

The linkage structure 205, embodiments of which are illustrated in FIGS. 3A to 4B, is convertible between an extended state 200a (FIGS. 3A and 4A) and a retracted state 200b (FIGS. 3B and 4B). The system 900 may be configured such that the mobile unit 100 may be in either of the elevated state 100a or the compact state 100b when the linkage structure 205 is in either of the extended state 200a or the retracted state 200b. Preferably, when the mobile unit 100 is in a compact state 100b, the linkage structure 205 is in the retracted state 200b. Preferably, when the mobile unit 100 is in the elevated state 100a, the linkage structure 205 is configured to be in the extended state 200a ready for use.

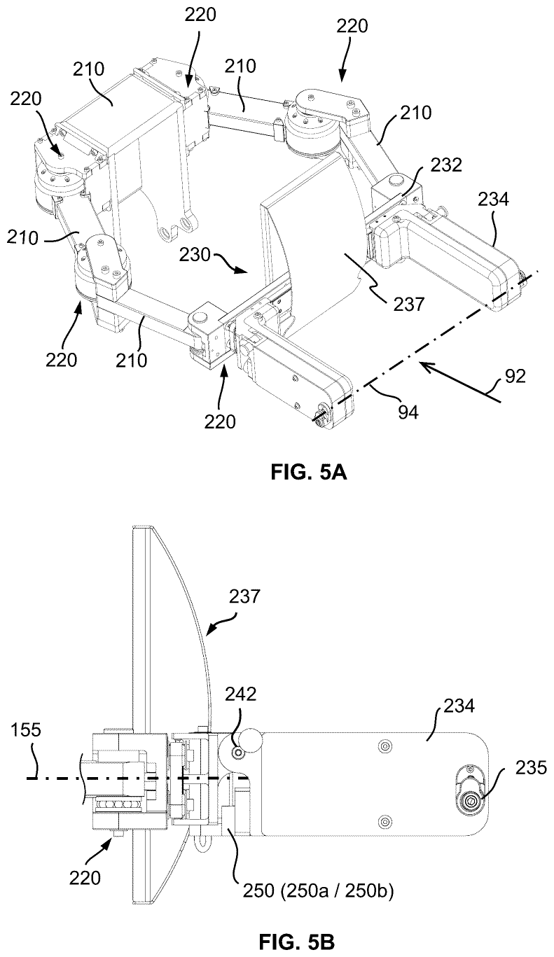

The support interface 230 is configured to be adjustable relative to the linkage structure 205 to provide better conformance to the user 80. In some examples, the support interface 230 includes a backrest 237 to provide support to the back of the user. The backrest 237 may be compliant or elastic. Alternatively, the backrest 237 may be relatively rigid to provide adequate support. Optionally, the backrest 237 may be a convex curved panel to provide more contact area with the lower back of the user. In the embodiments of FIGS. 5A and 5B, the support interface 230 includes a mechanism 240 having one or more pivot joints 242. The one or more pivot joints 242 provides for a first limited articulation of the support about a lateral axis 94, in which the limited articulation is a rotation is within a range detectable by the one or more sensors 250. The limited displacement of the support interface 230 relative to the linkage structure 205 is configured to be within a range detected by the one or more sensors 250.

In the non-limited examples illustrated, the support interface 230 may include a support member 232 to which the harness 290 may be secured. In some embodiments, the support interface 230 may also include arms 234 extending from the support member 232. In use, the arms 234 may be on either side of the user's hips, waist, thighs or, more generally, the torso/trunk. The support interface 230 may define a recess for receiving the user 80. In some embodiments, the support interface 230 may abut or contact the hip (pelvis region) of the user 80 and hence provide a degree of support to the user. Each of the arms 234 may be configured with at least one fastener 235 for attaching the harness 290.

The device 200 includes one or more sensors 250 coupled to the support interface 230 to sense forces acting on the support interface 230. In an embodiment, two force sensors 250a/250b are coupled to opposing sides of the support interface 230. The two force sensors 250a/250b are disposed spaced apart from each other along a lateral direction 94 of the support interface 230, with the lateral direction 94 being transverse to the supporting direction 92. The supporting direction 92 may be defined as extending from the support interface 230 toward the linkage structure 205.

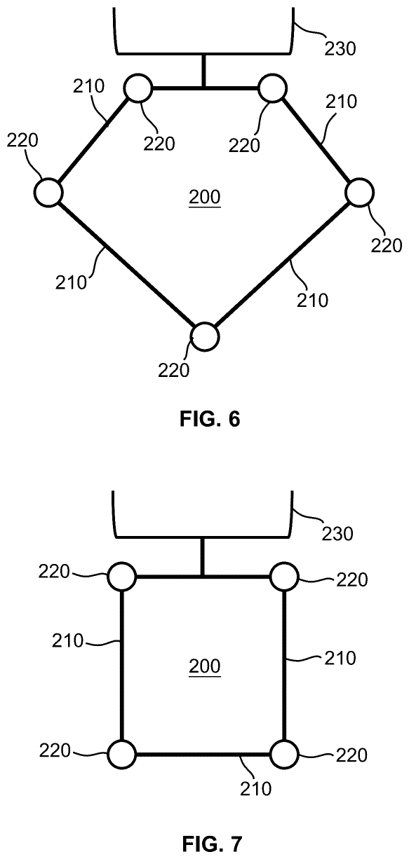

FIGS. 6 and 7 illustrate other embodiments of the linkage structure 205. In FIG. 6, the linkage structure 205 is a pentagonal structure having five linkages 210 and five lower-pair joints 220 (or rotary joints) providing the support interface 230 a two DOF movement. In this configuration, two lower-pair joints may be lockable joints 260 to lock the support interface 230 relative to the base 110. In FIG. 7, the linkage structure 205 is a quadrilateral structure comprising four linkages 210 and four lower-pair joints 220 or rotary joints providing the support interface 230 a one DOF movement. In this configuration, one lower-pair joint may be a lockable joint 260 to lock the support interface 230 relative to the base 110.

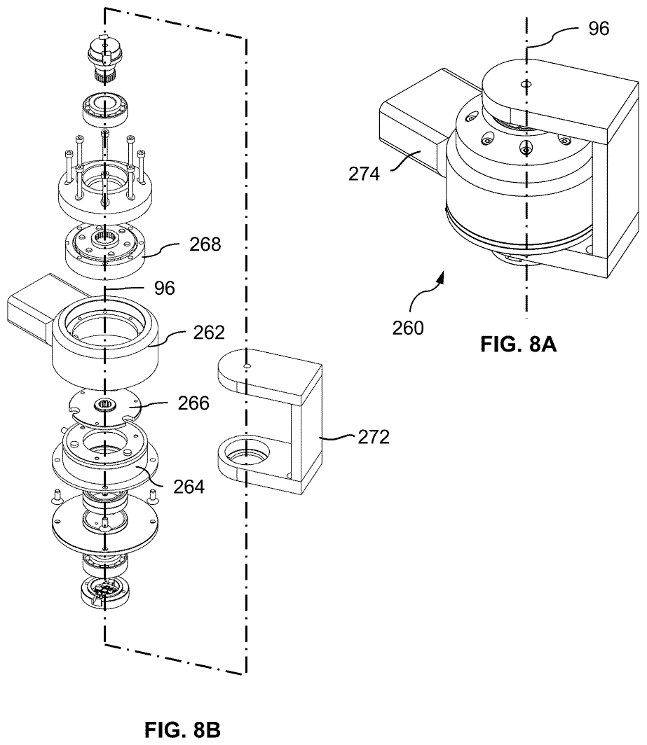

FIG. 8A and FIG. 8B illustrate a lockable joint 260 according to an embodiment of the present disclosure. The lockable joint 260 includes an independently actuated braking mechanism. The lockable joint 260 comprises a housing 262 defining a joint axis 96; a first friction member 264 and a second friction member 266 disposed interior of the housing 262 along the joint axis 96. In some embodiments, the first friction member 264 and the second friction member 266 may be biased (e.g., spring loaded) away from each other. The first friction member 264 and the second friction member 266 may be magnetically actuated to engage each other to produce a braking torque. In other words, the friction members 264/266 may be a pair of magnetically actuated friction members 264/266.

Further, the lockable joint 260 may further include a gear box 268, such as a planetary gear box, in engagement with the pair of magnetically actuated friction members 264/266. The gear box 268 is configured to increase the braking torque between the pair of magnetically actuated friction members 264/266. The braking torque may be adjusted by varying a gear ratio of the gear box 268. Advantageously, this enables an adjustable locking force at the lockable joint 260. In some examples, for user 80 with a higher risk of falling, the lockable joint 260 may be configured with a lower braking torque such that the linkage structure 205/support interface 230 may be locked in position as quickly as possible. In other examples, a higher braking torque may be set so that the device 200 provides a certain amount of supportive assistance even when the user 80 is not falling. The lockable joint 260 includes a first coupling element 272 and a second coupling element 274. The first coupling element 272 couples a first linkage 210 with the lockable joint at the joint axis 96, such that the first coupling element 272 is rotatable about a shaft (the shaft being parallel to the joint axis 96). The second coupling element 274 may extend rigidly from the housing 262, and be coupled to a second linkage. Such a lockable joint 260 may be selected for use in the present system 900 to provide a comparatively lightweight and low profile (lower height) device 200.

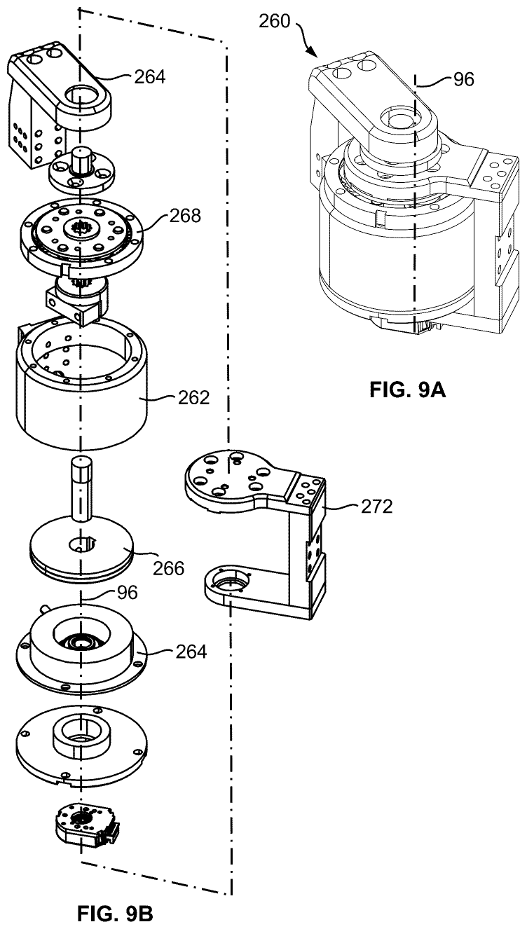

FIG. 9A and FIG. 9B shows a lockable joint 260 according to another embodiment of the present disclosure. In this embodiment, both the first coupling element 272 and the second coupling element 274 are coupled to the shaft (in which the shaft is parallel to the joint axis 96). This provides the lockable joint 260 with a higher profile and a sturdier frame.

The controller 500 may be in signal communication with each of the magnetically actuated friction members 264/266 to lock/release the lockable joint 260, to vary the gear ratio of the gear box 268, or a combination of both. The gear ratio is set before the device 200 is in use by a user 80, i.e., the strength of the braking torque is not variably controlled when the device 200 is responding to a fall or a potential fall. The response time of the present device 200 is intentionally much shorter than a time required by a conventional fall-prevention apparatus to change the stiffness at a variable-stiffness joint.

Some embodiments of the device 200 may be made available in the form of a module, so that the same device 200 may be interchangeably coupled to different types of mobile units 100. The modular embodiment of the device 200 may be configured with the controller 500 disposed thereon, e.g., the controller 500 may be coupled to part of one of the linkages 210.

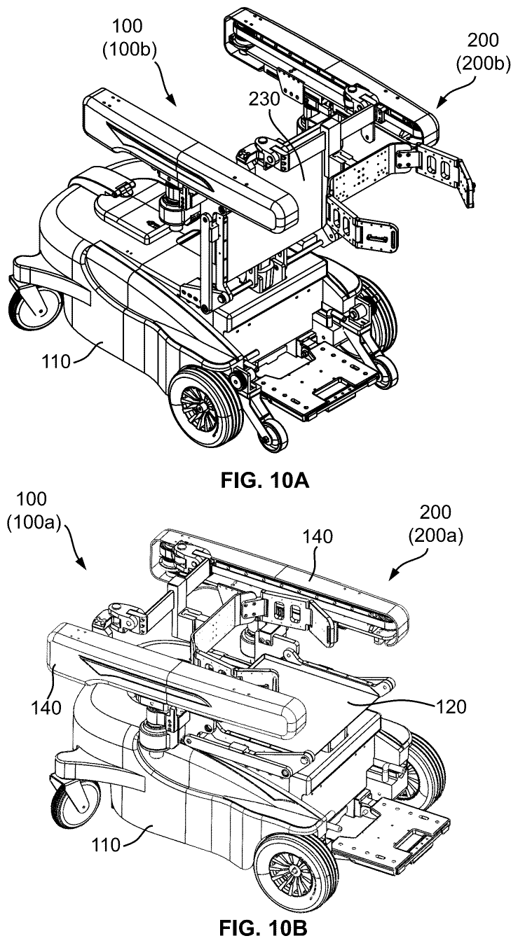

FIGS. 10A and 10B illustrate a system 900 according to another embodiment of the present disclosure. Similar to the embodiment of FIGS. 2A and 2B, the system 900 may include a base 110 and a device 200 movably coupled to the base 110. The mobile unit 100 may be convertible between an elevated state 100a (FIG. 10A) for providing a support to the user 80 during activities and a compact state 100b (FIG. 10B) for supporting the user 80 when seated.

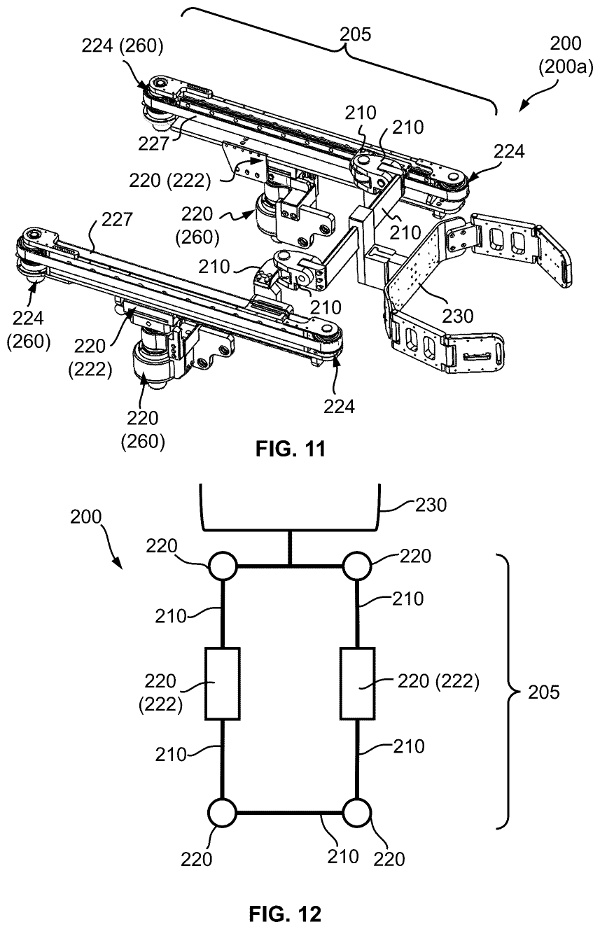

FIGS. 11 to 13 illustrate a device 200 according to another embodiment. The device 200 includes a linkage structure 205 having a plurality of linkages 210 and a plurality of lower-pair joints 220, and a support interface 230 coupled to the linkage structure 205 or the linkages 210 for providing support to the user 80. One or more of the lower-pair joints 220 may be an independently lockable joint. Each of the lower-pair joints 220 may be coupled between respective pair of linkages 210. The plurality of linkages 210 and the plurality of lower-pair joints 220 are operably coupled to enable a relative movement of the support interface 230 relative to the base 110. The prismatic joints 222 may each be disposed interior of a respective arm rest 140 or arm rest housing of the device 300 to save space.

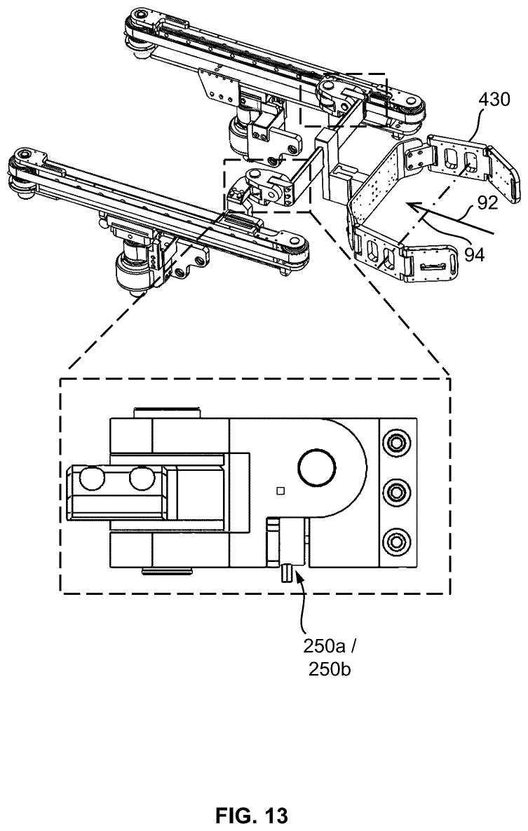

The embodiment of FIGS. 11 and 13 may be schematically represented as a closed kinematic chain of interconnected linkages for kinematic analysis, e.g., as shown in the diagram of FIG. 12. In this example, there are six linkages 210 and six lower-pair joints 220. In this example, two of the lower-pair joints 220 are prismatic joints 222, and another two lower-pair joints 220 being rotary joints 260. Each prismatic joint 222 further includes two rotary joint 224 spaced apart and driving a belt 227. Four of the six lower-pair joints 220 are independently lockable joints 260. One of the rotary joints 224 of each prismatic joint 222 is preferably a lockable joint 260. When the lockable joints 260 are locked, the linkages 210 are locked in position and orientation relative to one another. Similarly, two force sensors 250a/250b may be coupled to opposing sides of the support interface 230. The two force sensors 250a/250b may be disposed spaced apart from each other along/parallel to a lateral axis 94 of the support interface 230, with the lateral axis 94 being transverse to the supporting direction 92.

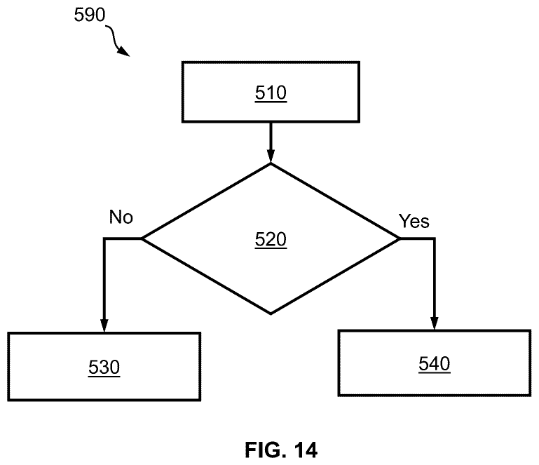

FIG. 14 illustrates a schematic diagram of a method 590 according to embodiments of the present disclosure. The method 590 is useful for fall detection or potential fall detection/prediction. In one aspect, the method 590 also a balance assistive method.

As described above, one or more sensors 250 (e.g., force sensors) may be installed between the device 200 and the support interface 230 at a rotary joint. Preferably two sensors are installed symmetrically at each side of the device 200. When the user 80 wearing the harness is able to support himself/herself, part of the body weight of the user is transferred through the support interface to the sensors 250. When the user is about to fall or at the start of falling, the sensors 250 will detect a sudden change of weight or a sudden increase in the forces exerted on the support interface 230. The controller 500 is configured to receive sensor signals from the sensors 250 continuously, and to analyse the sensor signals to check for abnormality or an abnormal pattern in the forces. A fall detection algorithm or a balance assistive algorithm may be executed by the controller 500 to determine if action is required. If the controller 500 determines that the forces detected are within a normal range (e.g., the direction of the forces may be taken into consideration in addition to the magnitude of the forces sensed), the controller 500 may determine that no action is required. If the controller 500 determines that the forces detected are indicative of an abnormal situation, the controller 500 may be configured to lock the device 200 and terminate movement of the base 110. For example, responsive to an abnormality in the support force, the controller 500 may independently actuate at least one of the lockable joints 260 to lock the support interface 230 relative to the base 110. In embodiments where the base 110 is part of a mobile unit 100, in addition to locking the support interface 230 relative to the base 110, the controller 500 may be configured to stop all movement of the base 110.

Examples of the abnormality in the force detected may include any one or more of the following: (i) an average of the forces detected exceeding a first threshold: (ii) a difference in the forces detected between the two force sensors (on either side) exceeding a second threshold: (iii) a sudden change in the forces detected; and (iv) the magnitude of one or more of the forces detected exceeding a third threshold.

In some embodiments, the abnormality in the forces detected may be determined by obtaining an average value of the forces from force sensors 250 disposed on opposing sides of the user 80, and determining whether the average value exceeds a pre-set threshold as per Equation 1 below.

$${F}_{average} = \frac{{F}_{left} + {F}_{right}}{2} \qquad ( 1 )$$

$$if ( {F}_{average} > {threshold}_{fall} ) , isFall = true$$

A user falling on either side (right or left side) will exert different support forces on the support interface 230, e.g., the force sensor on the right side will register a higher value than the force sensor on the left side if the user is falling towards the right side. The controller 500 may be configured to give more weightage to the force detected by the sensor on the right side than on the left side. The controller 500 may be configured to take into account of the lateral support interface position of the sensor for computing a left-to-right force ratio. The resultant force value may be a sum of normalized force values from the sensors on each side, multiplied by the left-to-right ratio. If the resultant force detected exceeds a pre-set threshold, the controller may be configured to consider that a fall has been detected, with reference to Equation 2 below.

$${ratio}_{r} = 0.5 + \frac{{interface}_{lateral}}{{lateral}_{m ax}} * 0.5 \qquad ( 2 )$$

$${ratio}_{l} = 1 - {ratio}_{r}$$

$${F}_{ratio} = \frac{{F}_{l}}{{F}_{l \_ max}} * {ratio}_{l} + \frac{{F}_{r}}{{F}_{r \_ max}} * {ratio}_{r}$$

$$if ( {F}_{ratio} > {threshold}_{fall} ) , isFall = true$$

As described in the foregoing, the device 200 is configured to determine if a fall is detected or predicted, and to respond to a fall being detected/predicted by changing from an unlocked state in one time instant to a locked state in a next time instant, in which the device 200 is a flexible multi-DOF body (compliant body) in the unlocked state, and in which the device 200 is a rigid body in the locked state. Once the device 200 is in the locked state, the system 900 offers sufficient support to the user 80 such that the user 80 is prevented from falling.

The present method and device are configured to provide instantaneous support at the critical time when the user is about to lose balance or has just lost balance, and before the user actually falls to the ground. Preferably, system 900 is locked (i.e., the device 200 is locked into a rigid body and the base is immobilized) for a sufficient period time for the user 80 to regain balance aided or unaided by another person. Preferably, the device 200 is unlocked (compliant) when the user 80 is able to balance himself/herself. In this way, the system 900 poses less of an intrusion and inconvenience to the user and also provides the user with a safe-guarded way to build up his/her ability to balance by his/her own efforts, facilitating better rehabilitation outcomes

The device 200 may be configured to have a relatively low inertia, conforming and compliant to the user's movement during activities, while only providing support upon prediction or detection of a fall. Further, in some embodiments, the device 200 as well as the base 110 may be decoupled from the user 80 such that a zero or near zero impedance/resistive force is applied by the system 900 on the user during normal activities thus enabling greater maneuverability for the user when there is no fall or no predicted fall. Preferably, the user 80 is not being actively supported at all times, e.g., when there is no fall or potential fall detected. In contrast, conventional fall prevention methods maintain an active force on the user 80.

As will be understood from the foregoing description, the system 900 differs from conventional fall-prevention apparatus. The present system 900 is configured to resist movement of the user starting at a time instant when a fall or a potential fall is detected, in addition to supporting the user even when the user is not in a fall. That is, the present system 900 can serve as a balance-assistive apparatus. Overall, the system 900 is safer. For example, in the event of a fall, the present system 900 is configured to instantaneously provide a reactive resistance supporting force instead of an active assistive supporting force. The present system 900 can achieve comparable performance with a conventional system at a lower cost while assuring a greater degree of safety. The system 900 may support the user from the front if it is so desired, e.g., if the user 80 lacks confidence to step out with no visible support in front. Advantageously, the system 900 can support the user from the back so that that the system 900 is non-intrusive or minimally intrusive to the user's activities.

Some conventional apparatus put the actuating mechanism at the base so as to provide greater stability and also provide joints of variable stiffness so that the user can be gently handled. As can be appreciated from the foregoing description, the present device 200 may be operable between a compliant state and a rigid body state independent of the base 110, but it also places the actuatable mechanisms (e.g., lockable joints) at a height near the reference plane 155 at a height from the base 110. In other words, the lockable joints are locally actuatable, with the entire braking mechanism of a lockable joint being disposed at the joint. The present device 200 may be described having binary states: at any one time, the present device 200 is in one of two possible states: a compliant body state and a rigid body state, with no gradually varying states in between the compliant body state and the rigid body state.

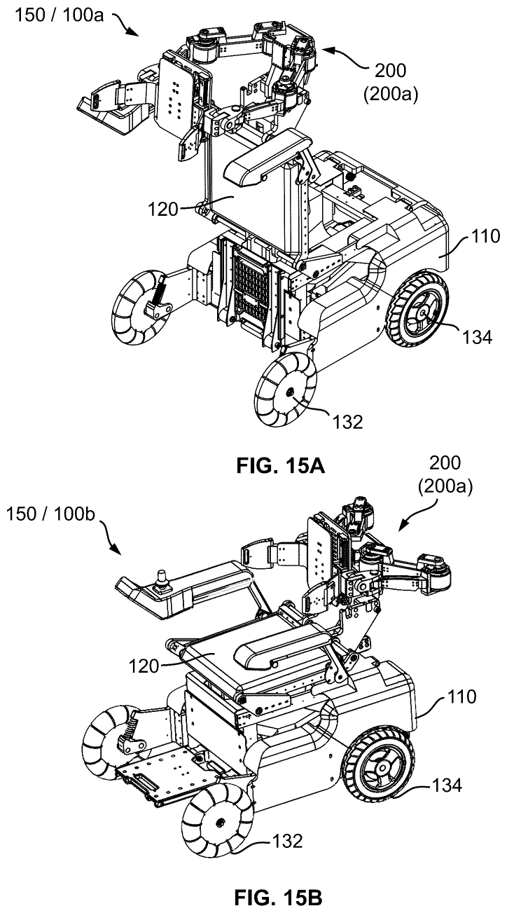

FIG. 15A is a perspective view of another embodiment of the system 900 in which the device 200 is integrated with a mobile unit 100. FIG. 15A shows the mobile unit 100 in an elevated state 100a. FIG. 15B shows the mobile unit 100 in a compact state 100b which can also serve as a wheelchair or a seat 120. As illustrated, the mobile unit 100 may be convertible between the elevated state 100a and the compact state 100b.

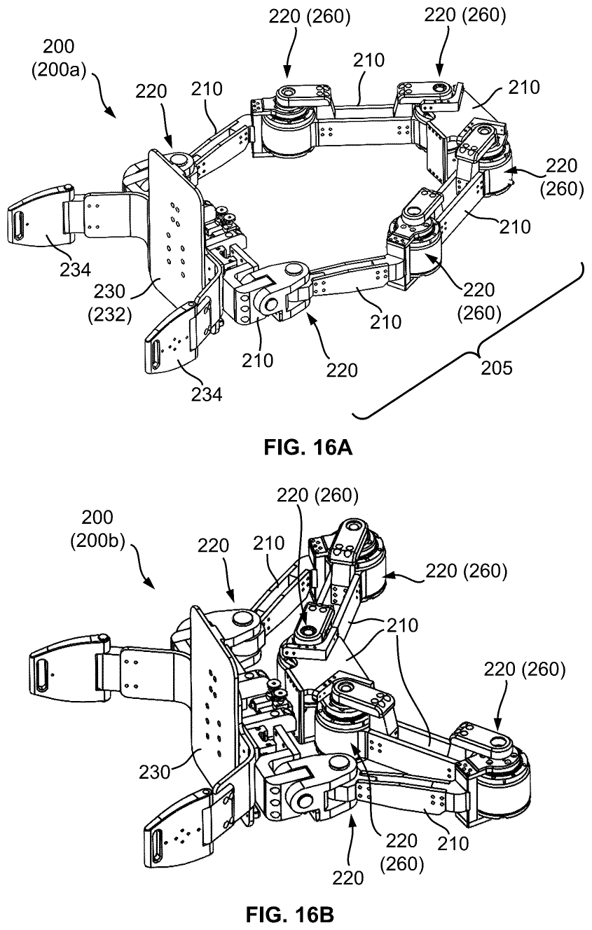

FIG. 16A and FIG. 16B are perspective views illustrating another embodiment of the device 200 in greater detail. The device 200 may include a linkage structure 205 having a plurality of linkages 210 and a plurality of lower-pair joints 220, and a support interface 230 coupled to the linkage structure 205 or the linkages 210 for providing support to the user 80. Each of the lower-pair joints 220 may be coupled between a respective pair of linkages 210. Therefore, the plurality of linkages 210 and the plurality of lower-pair joints 220 operably coupled to collectively form the linkage structure 205.

In this embodiment, for the sake of symmetry, preferably an even number of the lower-pair joints 220 is an independently lockable joint 260, i.e., a lockable joint that is also an independent joint. The lockable joint 260 is a free-joint when not actuated. When the lockable joint 260 is locked, the first linkage 210 and the second linkage are locked in position and/or orientation relative to one another. Upon actuating all of the four lockable joints, the linkage structure 205 is restricted and prevented from movement in all of the 3-DOF directions. The result is that the entire linkage structure 205 instantaneously changes from a compliant body into a rigid body, locking the support interface 230 in position relative to the base 110.

The linkage structure 205, embodiments of which are illustrated in FIGS. 3A to 4B, is convertible between an extended state 200a (FIGS. 15A and 16A) and a retracted state 200b (FIGS. 15B and 16B). The system 900 may be configured such that the mobile unit 100 may be in either of the elevated state 100a or the compact state 100b when the linkage structure 205 is in either of the extended state 200a or the retracted state 200b. Preferably, when the mobile unit 100 is in a compact state 100b, the linkage structure 205 is in the retracted state 200b. Preferably, when the mobile unit 100 is in the elevated state 100a, the linkage structure 205 is configured to be in the extended state 200a ready for use.

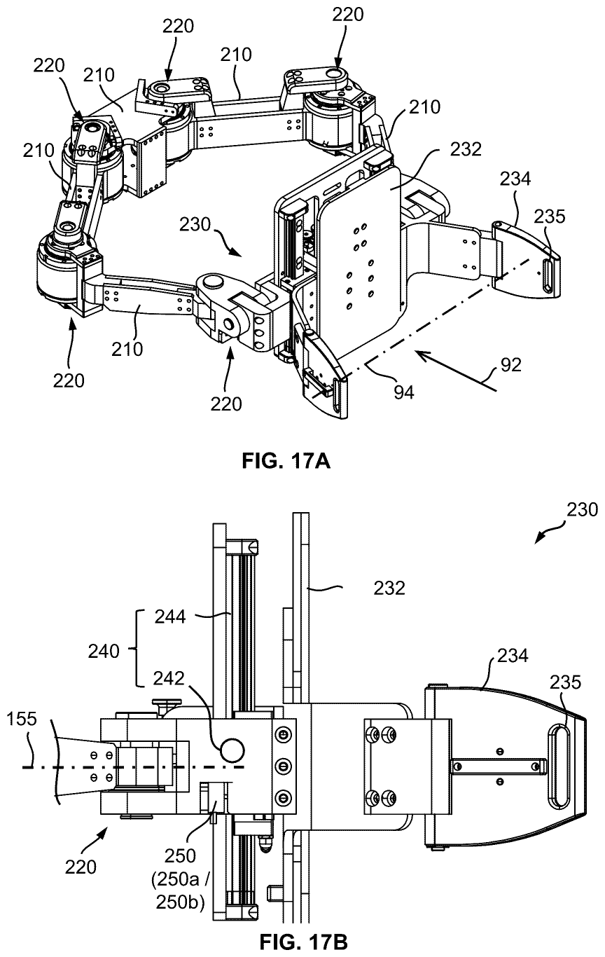

The support interface 230 may be configured to be adjustable relative to the linkage structure 205 to provide better conformance to the user 80. In the embodiments of FIG. 17A and FIG. 17B, the support interface 230 includes a mechanism 240 having one or more pivot joints 242 and one or more translational joints 244. The one or more pivot joints 242 provides for a first limited articulation of the support about a lateral axis 94, in which the limited articulation is a rotation is within a range detectable by the one or more sensors 250. The translational joint 244 provides for a second limited articulation or a translation in which the support interface 230 may be slidably displaced relative to the linkage structure 205, the linkage structure 205 being disposed to define a reference plane 155. The limited displacement of the support interface 230 relative to the linkage structure 205 is configured to be within a range detected by the one or more sensors 250.

The support interface 230 may include a support member 232 to which the harness 290 may be secured. In some embodiments, the support interface 230 may also include arms 234 extending from the support member 232. In use, the arms 234 may be on either side of the user's hips, waist, thighs, or, more generally, the torso/trunk of the user. Each of the arms 234 may be configured with a slot 235 for attaching the harness 290. The arm 234 may include any one of the following, e.g., buckle, fastener, or a slotted plate with a slot or other element 235, for attachment to a harness 290.

All examples described herein, whether of apparatus, methods, materials, or products, are presented for the purpose of illustration and to aid understanding, and are not intended to be limiting or exhaustive. Modifications may be made by one of ordinary skill in the art without departing from the scope of the invention as claimed.

1. A device, comprising:
a support interface;
one or more sensors disposed to sense forces exerted on the support interface; and
a linkage structure having a plurality of lower-pair joints and a plurality of linkages, the support interface being coupled to one of the plurality of linkages, each of the plurality of lower-pair joints coupling two of the plurality of linkages such that the linkage structure defines a closed kinematic chain, wherein a selected plurality of the lower-pair joints is a plurality of lockable lower-pair joints, each of the plurality of lockable lower-pair joints having a locally actuatable braking mechanism that is actuatable independently of any other of the plurality of lower-pair joints.

2. The device as recited in claim 1, wherein the lockable lower-pair joint is actuatable to lock respective pairs of the plurality of linkages relative to one other.

3. The device as recited in claim 1, wherein the linkage structure changes from being a compliant structure in one instant to being a rigid body in a next instant in response to the selected plurality of the lower-pair joints being actuated from an unlocked state to a locked state.

4. The device as recited in claim 1, wherein two of the one or more force sensors are disposed spaced apart from each other along a lateral axis of the support interface, the lateral direction being transverse to a supporting direction defined as extending from the support interface toward the linkage structure.

5. The device as recited in claim 1, wherein the locally actuatable braking mechanism comprises a pair of magnetically actuated friction members.

6. The device as recited in claim 5, wherein the lockable lower-pair joint comprises a gear box in engagement with the respective pair of magnetically actuated friction members, and wherein the gear box is configured to increase a braking torque between the respective pair of magnetically actuated friction members.

7. The device as recited in claim 6, wherein the braking torque is configurable by varying a gear ratio of the gear box.

8. The device as recited in claim 1, wherein the support interface is coupled to the linkage structure such that the support interface is displaceable relative to the linkage structure in three Degrees-of-Freedom (DOF).

9. The device as recited in claim 1, wherein the linkage structure comprises six lower-pair joints and six linkages, and wherein each of four of the six lower-pair joints are lockable lower-pair joint is lockable independently of any other of the six lower-pair joints.

10. The device as recited in claim 1, wherein at least two of the plurality of lower-pair joints are prismatic joints.

11. The device as recited in claim 1, wherein the support interface is configured to support a part of the hips of a user.

12. The device as recited in claim 1, further comprising a harness coupled to the support interface, wherein the harness is wearable about at least a part of a torso of a user.

13. The device as recited in claim 1, further comprising a controller, the controller being configured to:
determine if the forces sensed by the one or more sensors are indicative of an abnormality; and
responsive to the abnormality being determined, locking the selected plurality of lockable lower-pair joints to provide a supporting force at the support interface.

14. The device as recited in claim 13, wherein the abnormality comprises any one or more of the following: (i) an average of the forces exceeds a first threshold; (ii) a difference between the forces sensed by two of the one or more sensors exceeds a second threshold; (iii) a change in the forces over a few time instants; and (iv) the magnitude of one or more of the forces exceeds a third threshold.

15. A balance-assistive system for use with a user, the balance-assistive system comprising:
a support interface having a harness, the harness being wearable by the user;
one or more sensors disposed to sense forces exerted on the support interface by the user;
a linkage structure having a plurality of lower-pair joints and a plurality of linkages, the support interface being coupled to one of the plurality of linkages, each of the plurality of lower-pair joints coupling two of the plurality of linkages such that the linkage structure defines a closed kinematic chain, wherein a selected plurality of the lower-pair joints is a plurality of lockable lower-pair joints, each of the plurality of lockable lower-pair joints having a locally actuatable braking mechanism that is actuatable independently of any other of the plurality of lower-pair joints;
a base, the linkage structure being coupled to the base; and
a controller, the controller being configured to lock the selected plurality of the lower-pair joints in response to determining an abnormality in the forces sensed, such that respective pairs of the plurality of linkages are locked relative to one another.

16. The balance-assistive system as recited in claim 15, wherein the controller is configured to stop any movement of the base in response to the abnormality being determined.

17. The balance-assistive system as recited in claim 15, wherein the abnormality comprises any one or more of the following: (i) an average of the forces exceeds a first threshold; (ii) a difference between the forces sensed by two of the one or more sensors exceeds a second threshold; (iii) a change in the forces over a few time instants; and (iv) the magnitude of one or more of the forces exceeds a third threshold.

18. The balance-assistive system as recited in claim 15, wherein the controller is configured to monitor the forces sensed over a period of time with the linkage structure in a compliant state.

19. The balance-assistive system as recited in claim 15, wherein responsive to the selected plurality of the lower-pair joints being locked, the linkage structure is changed from the compliant state to a rigid body state in which a supporting force is provided to the user.

20. The balance-assistive system as recited in claim 15, wherein the linkage structure comprises six lower-pair joints and six linkages, and wherein each of four of the six lower-pair joints is lockable lower-pair joint is lockable independently of any other of the six lower-pair joints.
